(19) United States
(12) Patent Application Publication
(10) Pub. No.: US 2002/0003498 A1
(43) Pub. Date: Jan. 10, 2002

(54) Electromagnetic field generation antenna for a transponder

(76) Inventors: Luc Wuidart, Pourrieres (FR); Michel Bardouillet, Rousset (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/860,029

(22) Filed: May 17, 2001

(30) Foreign Application Priority Data
May 17, 2000 (FR) 00/06302

(51) Int. Cl. H01Q 21/00

(52) U.S. Cl. 343/700 MS; 343/893

(57) ABSTRACT

An antenna for generating an electromagnetic field including several planar inductive cells parallel connected in an array and forming, in association with at least one capacitor, an oscillating circuit adapted to being excited by a high-frequency signal.

### BACKGROUND OF THE INVENTION

1. Field of the Invention

The present invention relates to systems using electromagnetic transponders, that is, transmitters and/or receivers (generally mobile) capable of being interrogated in a contactless and wireless manner by a unit (generally fixed), called a read and/or write terminal. Generally, transponders extract the power supply required by the electronic circuits included therein from the high-frequency field radiated by an antenna of the read and write terminal. The present invention applies to such systems, be they read-only systems, that is, including a terminal only reading the data from one or several transponders, or read/write systems, in which the transponders contain data that can be modified by the terminal.

2. Discussion of the Related Art

Systems using electromagnetic transponders are based on the use of oscillating circuits including a winding forming an antenna, on the transponder side and on the read/write terminal side. These circuits are intended for being near-field coupled when the transponder enters the field of the read/write terminal.

FIG. 1 very schematically shows a conventional example of a data exchange system of the type to which the present invention relates between a read/write terminal 1 and a transponder 10 of the type to which the present invention applies.

Generally, terminal 1 is essentially formed of a series oscillating circuit formed of an inductance L1 in series with a capacitor C1 and a resistor R1, between an output terminal 2 of an amplifier or antenna coupler (not shown) and a reference terminal 3 (generally, the ground). The antenna coupler belongs to a circuit 4 for controlling the oscillating circuit and exploiting received data including, among others, a modulator/demodulator and a microprocessor for processing the control signals and the data. The exploitation of the received data is based on a measurement of the current in the oscillating circuit or of the voltage thereacross. Circuit 4 of the terminal generally communicates with different input/output circuits (keyboard, screen, means of exchange with a server, etc.) and/or processing circuits, not shown. The circuits of the read/write terminal generally draw the power necessary to their operation from a supply circuit (not shown) connected, for example, to the electric supply system or to batteries.

A transponder 10, intended for cooperating with a terminal 1, essentially includes a parallel oscillating circuit formed of an inductance L2, in parallel with a capacitor C2 between two input terminals 11, 12 of control and processing circuits 13. Terminals 11, 12 are in practice connected to the input of a rectifying means (not shown), outputs of which form D.C. supply terminals of the circuits internal to the transponder. These circuits generally include, essentially, a microprocessor capable of communicating with other elements (for example, a memory), a demodulator of the signals received from terminal 1, and a modulator for transmitting information to the terminal.

The oscillating circuits of the terminal and of the transponder are generally tuned on the same frequency corresponding to the frequency of an excitation signal of the terminal's oscillating circuit. This high-frequency signal (for example, at 13.56 MHz) is not only used as a transmission carrier but also as a remote supply carrier for the transponder(s) located in the terminal's field. When a transponder 10 is located in the field of a terminal 1, a high-frequency voltage is generated across terminals 11 and 12 of its resonant circuit. This voltage, after being rectified and possibly clipped, is intended for providing the supply voltage of electronic circuits 13 of the transponder. For clarity, the rectifying, clipping, and supply means have not been shown in FIG. 1. In return, the data transmission from the transponder to a terminal is generally performed by modulating the load formed by resonant circuit L2, C2. The load variation is performed at the rate of a so-called back-modulation sub-carrier, of a frequency (for example, 847.5 kHz) smaller than that of the carrier.

The antennas of terminal 1 and of transponder 10 are, in FIG. 1, materialized by their equivalent electric diagrams, that is, inductances (neglecting the series resistances). In practice, a terminal 1 has a flat antenna L1 formed of a few circular turns (most often one or two turns) of relatively large diameter (for example, of a given value ranging between one and 4 inches) and antenna L2 of a transponder (for example, a card of credit card format) is formed of a few rectangular turns (most often from two to five turns) inscribed within a relatively small diameter (turns with a side from 2 to 3 inches) as compared to the diameter of antenna L1.

FIG. 2 is a simplified perspective view of a terminal and of a transponder illustrating a conventional example of antennas. Electronic circuits 4 of terminal 1, as well as capacitor C1 and resistor R1, are generally contained in base 6. Antenna L1 is, for example, supported by a printed circuit wafer 7 protruding from base 6. In FIG. 2, it is assumed that antenna L1 is formed of a single turn in which, when the terminal's oscillating circuit is excited by the high-frequency signal, a current I flows. The indicated direction of current I is arbitrary and this current is alternating. Transponder 10 is assumed to be a smart card integrating circuits 13 and antenna L2 of which includes two rectangular coplanar turns approximately describing the periphery of card 10. Capacitor C2 shown as separated from circuits 13 is generally formed by being integrated to the chip.

Conventional transponder systems generally have a limited range, that is, at a certain distance (d, FIG. 2) from the terminal, the magnetic field is insufficient to properly remotely supply a transponder. The minimum field generally ranges between 0.1 and 1 A/m according to the transponder's power consumption, which essentially differs according to whether it is or not provided with a microprocessor.

The remote supply range depends on the amount of magnetic flux emitted by the terminal or reader, which can be “intercepted” by a transponder. This amount directly depends on the coupling factor between antennas L1 and L2, which represents the flux proportion received by the transponder. The coupling factor (between 0 and 1) depends on several factors among which are the mutual inductance between antennas L1 and L2 and the respective size of the antennas, and the tuning of the oscillating circuits on the high-frequency carrier frequency. For given sizes and a given mutual inductance, the coupling is maximum when the oscillating circuits of the terminal and of the transponder are both tuned on the frequency of the remote supply carrier.

A conventional solution to increase the range consists of increasing the size of antenna L1 of the terminal. To keep the magnetic field, the intensity of the current of the excitation signal must then be proportionally increased. A first disadvantage of such a solution is that it increases the necessary system excitation power. A second disadvantage of such a solution is that such a current increase remains limited by the generator structure and requires components having significant size (in particular, a large cross-section of the conductor forming antenna L1). Further, the losses are proportional to the square of the current.

To attempt overcoming this second disadvantage, a known solution is to use, for relatively large antennas (for example, of portico type), a parallel oscillating circuit on the terminal side. This circuit is then voltage-driven and no longer current-driven, which results in a greater increase of the current in the antenna (assembled as a so-called “rejector” circuit) without requiring that this current to flow through the generator. Such a solution has the advantage of limiting losses. However, this solution still causes an increase in the power consumption (due to the voltage increase to increase the power). Further, the maximum field at the center of antenna L1 is generally set by standards.

Another disadvantage, mostly present for antennas of relatively large size, is that the magnetic field is not homogeneous in front of the antenna, that is, for a given distance, the intensity of the magnetic field strongly varies according to the position in a plane parallel to the antenna. This disadvantage of course cumulates with the foregoing when the range is desired to be increased by increasing the size of the antenna, that is, the surface area in which it is inscribed.

U.S. Pat. No. 5,142,292 discloses an antenna including a plurality of series-connected coils for transmitting electromagnetic energy.

### SUMMARY OF THE INVENTION

The present invention aims at overcoming the disadvantages of conventional transponder systems.

The present invention more specifically aims at improving the terminal efficiency, especially by optimizing the impedance matching of the oscillating circuit.

The present invention aims, in particular, at improving the range and/or the signal level available at a given distance, from a read and/or write transponder terminal.

The present invention also aims at improving the homogeneity of the magnetic field generated by a transponder read and/or write terminal.

The present invention also aims at providing a solution which is compatible with existing systems. More precisely, the present invention aims at providing a solution that requires no modification of the transponders and, preferably, no modification of the read/write terminal.

The present invention further aims at providing a solution generating no significant additional power consumption.

To achieve these and other objects, the present invention provides an antenna for generating an electromagnetic field including several planar inductive cells parallel connected in an array and forming, in association with at least one capacitor, an oscillating circuit adapted to being excited by a high-frequency signal.

According to an embodiment of the present invention, all cells have identical inductance values.

According to an embodiment of the present invention, the natural resonance frequency of the oscillating circuit is chosen to approximately correspond to the frequency of the excitation signal.

According to an embodiment of the present invention, the antenna is connected in series with the capacitor.

According to an embodiment of the present invention, the antenna is connected in parallel with the capacitor.

According to an embodiment of the present invention, the number of turns of each cell is chosen by taking account of the surface area in which the cells are inscribed together.

The present invention also provides a terminal for generating a high-frequency electromagnetic field for at least one transponder.

According to an embodiment of the present invention, the terminal's oscillating circuit includes a capacitor of greater value than the value that this capacitor should have if it was associated with an antenna of the same size but formed of a single cell.

The foregoing objects, features and advantages of the present invention, will be discussed in detail in the following non-limiting description of specific embodiments in connection with the accompanying drawings.

### BRIEF DESCRIPTION OF THE DRAWINGS

FIG. 1, previously described, very schematically shows an electric diagram of a conventional transponder system;

FIG. 2, previously described, shows an example of shapes of antennas of a conventional transponder system;

FIG. 3A very schematically shows a first embodiment of a terminal for generating an electromagnetic field according to the present invention;

FIG. 3B shows a simplified electric diagram of the first embodiment of the present invention; and

FIGS. 4A and 4B show, respectively as seen from a first and from a second surface, a second embodiment of an antenna according to the present invention.

### DETAILED DESCRIPTION

The same elements have been referred to with the same references in the different drawings. For clarity, these have been drawn out of scale and only those elements of a terminal or of a transponder which are necessary to the understanding of the present invention have been illustrated in the drawings and will be described hereafter. In particular, the circuits for processing and exploiting the exchanged data have not been detailed since they are conventional. They will most often be dedicated or programmable digital circuits. Further, the present invention applies whatever the type of transponder (credit card type, electronic label, etc.), be it or not provided with a microprocessor.

A feature of the present invention is to provide an array antenna, that is, an antenna formed of several independent and coplanar loops or cells that are connected in parallel.

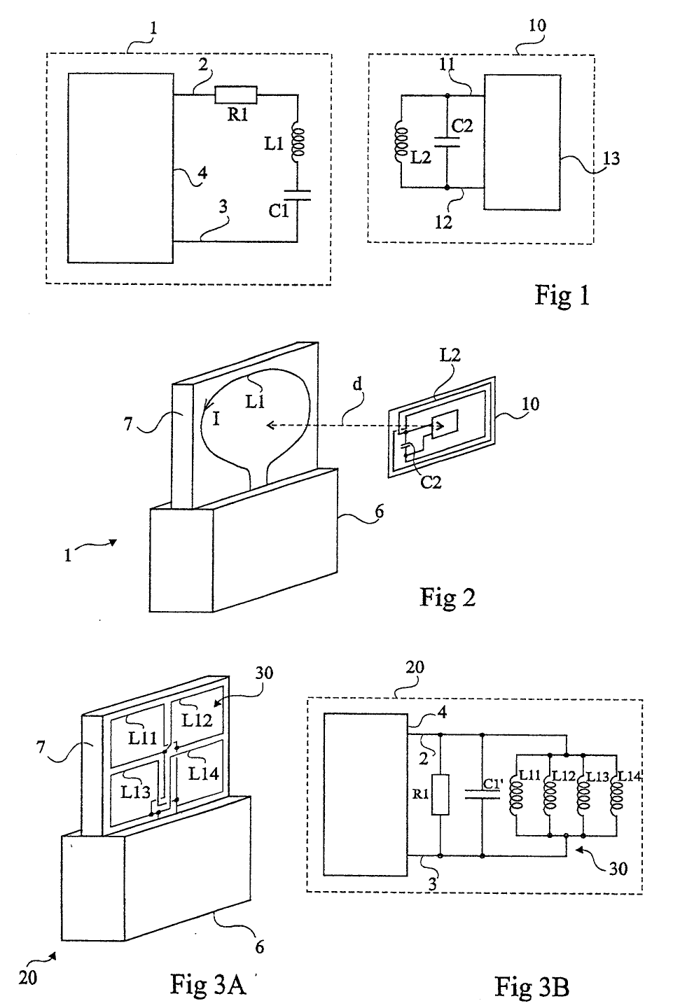

FIGS. 3A and 3B very schematically show a first embodiment of a terminal for generating an electromagnetic field according to the present invention. FIG. 3A illustrates an example of a structural implementation to be compared with the representation of FIG. 2. FIG. 3B shows the equivalent electric diagram to be compared with the representation of FIG. 1.

A terminal 20 according to the present invention differs from a conventional terminal by its oscillating circuit. For the rest, it includes circuits 4 for controlling, exploiting, and processing data, a base 6, and a support 7 for the antenna, for example, a printed circuit wafer on which are made the conductive tracks forming the antenna.

According to the present invention, antenna 30 of the oscillating circuit is formed of several coplanar and non-concentric cells or loops, which are placed or formed side by side on support 7, each cell being formed of one or several coplanar concentric turns. Electrically, this amounts to providing several (for example, four) inductances L11, L12, L13, and L14 connected, preferably, in parallel.

It should be noted that the association of the inductances in an antenna array must be such that all cells generate fields, the lines of which add (all are in the same direction).

In the embodiment of FIGS. 3A and 3B, the oscillating circuit itself is a parallel or “rejector” circuit, that is, resistor R1 and capacitor C1′ are connected in parallel with antenna 30. As an alternative, an antenna according to the present invention may be assembled in a series oscillating circuit, resistor R1 then being in series with capacitor C1′ and antenna 30 (that is, the parallel connection of inductances L11, L12, L13, and L14). A parallel or series oscillating circuit may be provided according to whether a current or voltage control is provided. The choice will be made, for example, according to the required excitation power.

Other alternatives may of course be envisaged to connect the inductances in parallel with a common capacitor.

Providing several distinct inductances to form the antenna has several advantages.

A first advantage of the present invention is that by providing several coplanar cells to form the terminal's oscillating circuit, the field lines are more homogeneous in the antenna's axis (a virtual axis approximately corresponding to the perpendicular line at the center of the circle in which the antenna cells are inscribed), whereby the power received by the transponder in the field is also more homogeneous for different lateral shifting positions with respect to the system's axis of symmetry.

Another advantage is that the circuit feasibility is guaranteed. Indeed, due to the high frequencies (several tens of MHz) of the carrier and to the antenna size (surface area) requirement to increase the range, the value of the capacitor required for a conventional antenna can become smaller than the stray capacitance of the inductance, making its realization impossible. By providing an association of several inductances in parallel, the use of one or several capacitors of greater value, and thus more easily greater than the respective stray capacitances of the inductances, is allowed. In the example of FIG. 3B, this amounts to saying that, for a given equivalent antenna surface area, the fact of placing four parallel inductances of the same value (L11=L12=L13=L14=L) divides the resulting value (for example, provides a resulting inductance L/4) and enables use of a capacitor C1′ of a value 4 times greater than the value that it would have had with a single cell of same inductance value. Indeed, to keep the tuning of the oscillating circuit on the frequency (corresponding to a pulse ω) of the excitation signal, relation 1/((L/4)*C1′)=ω² must be respected.

Another advantage of a parallel association of the cells forming the antenna is that by decreasing the value of the equivalent inductance, the overvoltage developed thereacross and, accordingly, the parasitic electric field resulting therefrom, are decreased.

Another advantage of the present invention is that its implementation requires no modification of the transponder. Further, on the terminal side, the modification is minor since the antenna of the present invention can include, like conventional antennas, two connection terminals only for the terminal's circuits.

It should be noted that capacitor C1′ (FIGS. 3A and 3B) can be replaced with several capacitors respectively associated with the different cells. However, an advantage of providing a capacitor common to all cells is that this enables maximizing its value so that there is no longer a risk that the value of the capacitor is of the same order of magnitude as the stray capacitances of inductances L11, L12, L13, and L14. Thus, the use of a cell array finds application, in particular (but not exclusively), in portico type systems where the respect of the condition of general size of the terminal's antenna would result in too small a capacitor C1 (FIG. 1). Further, since capacitors can be adjustable, it is preferable to perform a single adjustment.

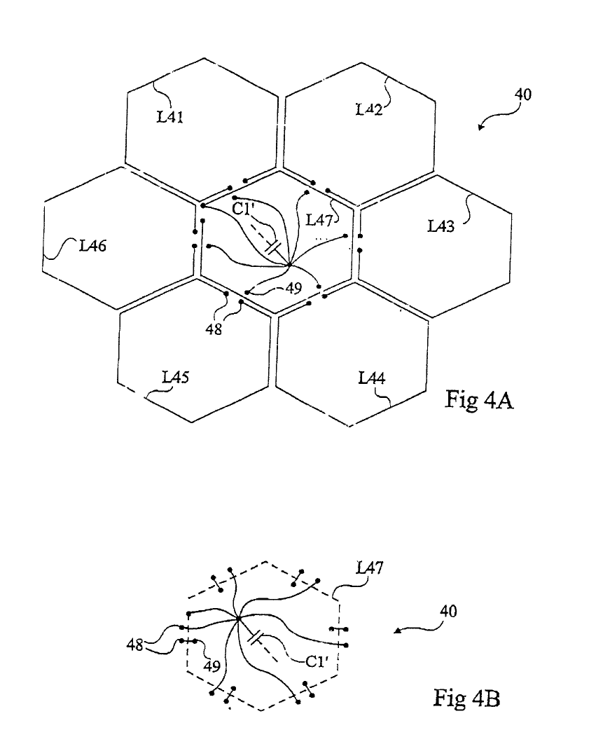

FIGS. 4A and 4B schematically show, respectively by a view from a first surface and from a second opposite surface, an antenna 40 according to a second embodiment of the present invention. The cells are placed in a “honeycomb”. For example, six cells L41, L42, L43, L44, L45, and L46 having the shape of a hexagonal spiral are arranged around a seventh cell L47 also in the form of a hexagonal spiral. Such a structure optimizes the homogeneity of the field lines. FIG. 4A shows, for example, the first surface of a printed circuit on which are formed the different cells of antenna 40 and FIG. 4B shows, for example, the second surface of this circuit enabling obtaining the interconnections. A capacitor C1 is either external or formed in the printed circuit (for example, across its thickness). The two ends of each spiral L41, L42, L43, L44, L45, and L46 and one end of central spiral L47 are connected to vias 48 enabling crossing of the printed circuit. The first ends are connected to a first electrode of capacitor C1 at the second surface (FIG. 5B). The second ends of the first six spirals cross back the circuit (by vias 49) inside of spiral L47, to be connected, with the second end thereof, to the second electrode of capacitor C1 at the first surface (FIG. 5A). To simplify the representation, only central spiral L47 has been shown (in dotted lines) in FIG. 4B.

In the example of FIGS. 4A and 4B, an association of cells in parallel assembled in a parallel oscillating circuit has been considered, but it should be noted that the optimizing of the surface occupied, obtained by the honeycomb structure can be valuable in a parallel association of the cells in a series oscillating circuit.

Of course, the present invention is likely to have various alterations, modifications, and improvements which will readily occur to those skilled in the art. In particular, the geometric sizing and the value of the inductances will be chosen according to the application and, in particular, to the desired range and to the desired excitation frequencies and powers. For example, after having determined the size of the cells and the value of the capacitance, the number of turns of the antennas is determined according to the inductances desired to respect the tuning. Further, the choice of the geometry (circular, rectangular, etc.) of the antennas may depend on factors (for example, the place of implantation, the terminal shape, etc.) other than those of the present invention.

To determine the number of turns of the cells of an antenna according to the present invention, account will preferably be taken of the following characteristics.

As a first approximation, it may be considered that the value of an inductance wound in a same plane is directly proportional to the square of the number of turns and to the average surface area in which the turns are inscribed. Magnetic field H, in the plane and at the center of a circular inductance of N turns of average diameter D, approximately amounts to N*I/D, where I represents the current. According to the present invention, this reasoning is applied while assuming that, whatever its shape (square, rectangular, hexagonal, circular, oval, etc.), a cell is inscribed in a circle of diameter D, as well as the antenna formed of the plurality of cells is inscribed in a circle of diameter D′. Based on this assumption, it is possible to determine the number of turns that the cells must have according to the other parameters that are determined. In particular, it will be chosen to enhance the equivalent inductance or the field according to the type of terminal and, more specifically, to the general size desired for the antenna.

Indeed, for an antenna of one cell, it may be considered that the inductance is four times as high for two turns than for a single one. Assuming an excitation by the same current, the field at the center and in the plane of the cell is doubled while passing from one to two turns.

By applying this reasoning to a comparison between a large antenna of a single cell and an antenna of same size of several cells connected in parallel and inscribed in the same surface, a relatively high number of turns may be chosen if it is desired to favor the field increase and a relatively small number of turns may be chosen to enhance a decrease of the equivalent inductance.

For example, the field resulting from 4 cells in parallel of 4 turns each is, at the center of the antenna, substantially the same as that of a cell of the same general surface area and of 2 turns, while the value of the equivalent inductance is divided by 4. This is a particularly valuable effect to increase the value of the oscillating circuit's capacitor and to get rid of the problems of stray capacitances in large antennas.

As a comparison, the equivalent inductance of 4 cells in parallel of 8 turns each is approximately the same as the inductance of a cell of same general surface area and of 2 turns while the resulting field is, at the center of the antenna, approximately doubled. This case will thus be favored for small antennas.

Among the applications of the present invention are contactless chip cards (for example, identification cards for access control, electronic purse cards, cards for storing information about the card holder, consumer fidelity cards, toll television cards, etc.) and read or read/write systems for these cards (for example, access control terminals or porticoes, automatic dispensers, computer terminals, and telephone terminals televisions or satellite decoders, etc.).

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An antenna for generating an electromagnetic field, including a plurality of planar inductive cells parallel connected in an array and forming, in association with at least one capacitor, an oscillating circuit adapted to being excited by a high-frequency signal.

2. The antenna of claim 1, wherein all cells have identical inductance values.

3. The antenna of claim 2, wherein a natural resonance frequency of the oscillating circuit is chosen to approximately correspond to a frequency of the excitation signal.

4. The antenna of claim 1, connected in series with the capacitor.

5. The antenna of claim 1, connected in series with the capacitor.

6. The antenna of claim 1, wherein a number of turns of each cell is chosen by taking account of the surface area in which the cells are inscribed together.

7. A terminal for generating a high-frequency electromagnetic field for at least one transponder, including the antenna of claim 1.

8. The terminal of claim 7, wherein the oscillating circuit includes a capacitor of greater value than a value that this capacitor should have if it was associated with an antenna of a same size but formed of a single cell.
